(19) United States
(12) Patent Application Publication
(10) Pub. No.: US 2026/0290158 A1
(43) Pub. Date: Sep. 24, 2026

(54) LANE IDENTIFICATION SYSTEM, LANE IDENTIFICATION DEVICE, AND LANE IDENTIFICATION METHOD

(71) Applicant: NEC Corporation, Tokyo (JP)

(72) Inventors: Daisuke IKEFUJI, Tokyo (JP); Hemant Shivsagar PRASAD, Tokyo (JP)

(73) Assignee: NEC Corporation, Tokyo (JP)

(21) Appl. No.: 19/473,597

(22) PCT Filed: Apr. 27, 2023
(86) PCT No.: PCT/JP2023/016732

§ 371 Date: Oct. 8, 2025

(51) Int. Cl. G08G 1/04; G08G 1/01; G08G 1/015; G08G 1/052

(52) U.S. Cl. CPC G08G 1/04; G08G 1/0137; G08G 1/015; G08G 1/052

(57) ABSTRACT

A lane identification system according to the present disclosure comprises: an optical fiber (10) that is embedded in a road (R); a measurement unit (21B) that measures, on the basis of an optical signal received from the optical fiber (10), the vibration characteristics of vibrations generated on the road (R); and an identification unit (23B) that derives vibration intensity during a vehicle passed through an observation point, on the basis of vibration characteristics, which are among the vibration characteristics, during the vehicle passed through the observation point on the road (R), and identifies the lane in which the vehicle that passed through the observation point is traveling, on the basis of the derived vibration intensity and a vehicle section of the vehicle that passed through the observation point.

### TECHNICAL FIELD

The present disclosure relates to a lane identification system, a lane identification device, and a lane identification method.

### BACKGROUND ART

By optical fiber sensing using an optical fiber embedded in a road as a line sensor, a sensing device connected to the optical fiber can measure the amplitude of vibration of a vehicle traveling on the road over the entire section in which the optical fiber is embedded. The sensing device can also visualize the trajectory of the vehicle by representing the measured amplitude of the vibration of the vehicle in a graph of the distance from the sensing device and the time.

On the other hand, in recent years, studies have been conducted on using autonomous vehicles on expressways. In order to achieve this, at a junction such as an interchange or a junction on an expressway, it is necessary to grasp the presence or absence of a vehicle traveling in the traveling lane before the junction in order for the autonomous vehicle to safely enter the traveling lane without reducing the speed.

Here, an example in which an autonomous vehicle joins an expressway will be described with reference to FIG. 1. The example of FIG. 1 is an example in which an autonomous vehicle AC merges with a road R which is an expressway having two lanes on each side (a traveling lane and a passing lane). In the example of FIG. 1, an optical fiber 10 for optical fiber sensing is buried along the road R on the road shoulder of the road R.

In a case where the autonomous vehicle AC joins the road R, in order to safely and smoothly enter the traveling lane, it is necessary to grasp whether there is a traveling vehicle in the merging traveling lane from about 2 to 10 seconds before the merging time.

Therefore, upon the autonomous vehicle AC joins the road R, the range that the autonomous vehicle AC should grasp is the merging point and the range before the merging point (hereinafter, referred to as attention region).

Here, in the optical fiber sensing using the optical fiber 10 as a line sensor, it is possible to grasp the presence or absence of a vehicle traveling in the attention region. However, it is difficult for the optical fiber sensing to grasp which one of the traveling lane and the passing lane the vehicle traveling in the attention region is traveling in.

In the example of FIG. 1, a fixed point monitoring system such as a camera is installed in front of the merging point of the road R. However, the range that can be monitored by the camera is a range centered on the merging point, and the entire attention region cannot be monitored. There are many cases where no fixed point monitoring system is installed at the merging point of the road R.

Therefore, recently, a technique for identifying a lane on which a vehicle is traveling by using optical fiber sensing has been proposed (for example, PTLs 1 and 2).

For example, the technique described in PTL 1 uses the fact that the signal intensity acquired by optical fiber sensing increases in a case where vibration is applied in a lane close to the optical fiber, and the signal intensity acquired by optical fiber sensing decreases in a case where vibration is applied in a lane away from the optical fiber to identify the lane on which the vehicle is traveling.

In a case where pavement of a road is different for each lane, the technique disclosed in PTL 2 uses the fact that observation information capable of identifying a lane on which a vehicle is traveling can be acquired by optical fiber sensing to identify the lane on which the vehicle is traveling.

### CITATION LIST

### Patent Literature

PTL 1: WO 2022/024208 A1

PTL 2: WO 2022/185922 A1

### SUMMARY OF INVENTION

### Technical Problem

As described above, the technique described in PTL 1 uses the fact that the signal intensity varies depending on a distance between the optical fiber and each lane to identify the lane on which the vehicle is traveling. However, since the signal intensity varies depending on the size of the vehicle, if the lane on which the vehicle is traveling is identified using only the signal intensity, there is a problem that identification accuracy is poor.

The technique disclosed in PTL 2 identifies the lane on which the vehicle is traveling by utilizing the fact that observation information capable of identifying the lane on which the vehicle is traveling can be acquired in a case where the pavement of the road is different for each lane. Therefore, the technique disclosed in PTL 2 has a problem that, in a case where the pavement of the road is the same between the lanes, even if the lane on which the vehicle is traveling can be identified, the identification accuracy is poor.

Therefore, in view of the above-described problems, an object of the present disclosure is to provide a lane identification system, a lane identification device, and a lane identification method capable of more accurately identifying a lane on which a vehicle is traveling.

### Solution to Problem

A lane identification system according to one aspect includes
an optical fiber embedded in a road,
a measurement unit that measures vibration characteristics of vibration generated on the road based on an optical signal received from the optical fiber, and
an identification unit that derives, based on a vibration characteristic during a vehicle passes through an observation point on the road among the vibration characteristics, a vibration intensity during the vehicle passes through the observation point, and identifies a lane on which the vehicle that has passed through the observation point is traveling based on the derived vibration intensity and a vehicle classification of the vehicle that has passed through the observation point.

A lane identification device according to one aspect includes
a measurement unit that measures vibration characteristics of vibration generated on the road based on an optical signal received from an optical fiber embedded in a road, and
an identification unit that derives, based on a vibration characteristic during a vehicle passes through an observation point on the road among the vibration characteristics, a vibration intensity during the vehicle passes through the observation point, and identifies a lane on which the vehicle that has passed through the observation point is traveling based on the derived vibration intensity and a vehicle classification of the vehicle that has passed through the observation point.

A lane identification method according to one aspect is a lane identification method executed by a lane identification device including
a measurement step of measuring vibration characteristics of vibration generated on the road based on an optical signal received from an optical fiber embedded in a road, and
an identification step of deriving, based on a vibration characteristic during a vehicle passes through an observation point on the road among the vibration characteristics, a vibration intensity during the vehicle passes through the observation point, and identifying a lane on which the vehicle that has passed through the observation point is traveling based on the derived vibration intensity and a vehicle classification of the vehicle that has passed through the observation point.

### Advantageous Effects of Invention

According to the above aspects, it is possible to provide a lane identification system, a lane identification device, and a lane identification method capable of more accurately identifying a lane on which a vehicle is traveling.

### BRIEF DESCRIPTION OF DRAWINGS

FIG. 1 is a diagram illustrating an example in which an autonomous vehicle joins a traveling lane of an expressway.

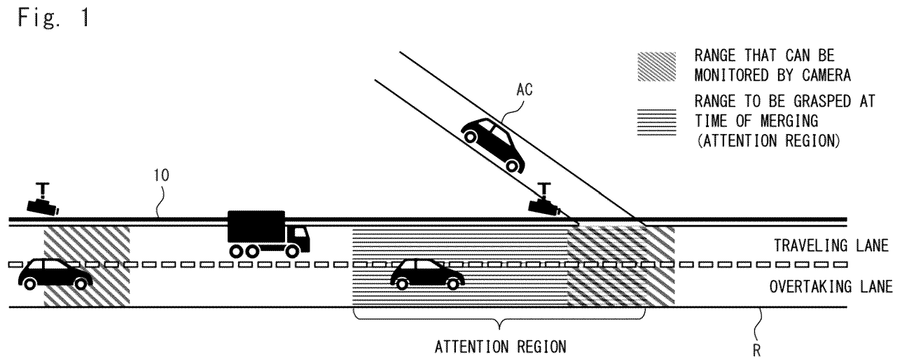

FIG. 2 is a diagram illustrating a schematic configuration example of a lane identification system according to a first example embodiment.

FIG. 3 is a diagram illustrating an example of measurement data of vibration generated by a learning unit and an identification unit according to the first example embodiment.

FIG. 4 is a diagram illustrating an example of vibration intensity derived by a learning unit and an identification unit according to the first example embodiment.

FIG. 5 is a diagram illustrating an example of statistical data indicating a relationship between vibration intensity in a case where a vehicle passes through an observation point on a road and a lane on which the vehicle that has passed through the observation point on the road is traveling, for each vehicle classification of the vehicle.

FIG. 6 is a diagram illustrating an example of a waveform length derived by a learning unit and an identification unit according to the first example embodiment.

FIG. 7 is a diagram illustrating an example of the number of peaks derived by the learning unit and the identification unit according to the first example embodiment.

FIG. 8 is a diagram illustrating a schematic operation example of the lane identification system according to the first example embodiment.

FIG. 9 is a diagram illustrating a schematic configuration example of a lane identification system according to a second example embodiment.

FIG. 10 is a diagram illustrating an example of statistical data indicating a relationship between a vibration intensity during a vehicle passes through an observation point on a road, a traveling speed of the vehicle, and a lane on which the vehicle that has passed through the observation point on the road is traveling, for each vehicle classification of the vehicle.

FIG. 11 is a diagram illustrating another example of measurement data of vibration generated by the learning unit and the identification unit according to the second example embodiment.

FIG. 12 is a diagram illustrating a schematic operation example of the lane identification system according to the second example embodiment.

FIG. 13 is a diagram illustrating a schematic configuration example of a lane identification system according to a third example embodiment.

FIG. 14 is a flowchart illustrating an example of a schematic operation flow of a lane identification system according to the third example embodiment.

FIG. 15 is a block diagram illustrating a hardware configuration example of a computer that implements the lane identification device according to each example embodiment.

### EXAMPLE EMBODIMENT

Example embodiments of the present disclosure are described below with reference to the drawings. The following description and drawings are omitted and simplified as appropriate for clarity of description. In the following drawings, the same elements will be denoted by the same reference signs, and redundant description will be omitted as necessary. Specific numerical values and the like shown below are merely examples for facilitating understanding of the present disclosure, and the present disclosure is not limited thereto.

### First Example Embodiment

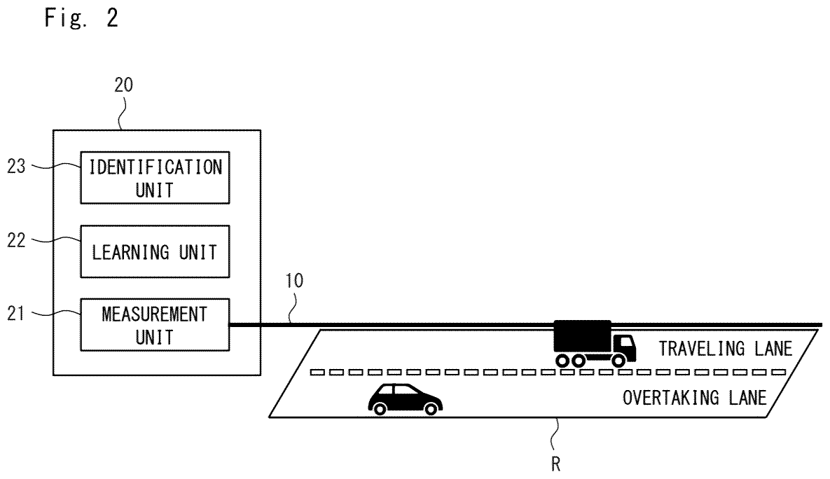

First, a schematic configuration example of a lane identification system according to the present first example embodiment will be described with reference to FIG. 2.

As illustrated in FIG. 2, the lane identification system according to the present first example embodiment includes an optical fiber 10 and a lane identification device 20.

The optical fiber 10 is embedded in a road R. Specifically, in the present first example embodiment, a road R is a two-lane road on one side (traveling lane and passing lane), and the optical fiber 10 is buried under the shoulder of the road R along the road R. However, the present disclosure is not limited thereto, and the road R may be a road with three or more lanes, and the optical fiber 10 may be buried under the median strip.

The lane identification device 20 is achieved by, for example, a sensing device such as a distributed fiber optic sensing (DFOS) device.

The lane identification device 20 includes a measurement unit 21, a learning unit 22, and an identification unit 23.

The optical fiber 10 is connected to the measurement unit 21.

The measurement unit 21 transmits pulsed light to the optical fiber 10.

The measurement unit 21 receives, from the optical fiber 10, backscattered light generated as pulsed light is transmitted through the optical fiber 10 as an optical signal.

Here, if vibration occurs on the road R, the vibration is transmitted to the optical fiber 10, and a characteristic (for example, wavelength) of the optical signal transmitted through the optical fiber 10 changes.

Therefore, the measurement unit 21 can detect vibration generated on the road R based on the optical signal received from the optical fiber 10. The measurement unit 21 can measure the amplitude of vibration generated on the road R based on the degree of change in the characteristic of the optical signal received from the optical fiber 10.

As described above, the optical fiber 10 functions as a sensor at a time where the measurement unit 21 detects vibration. In the optical fiber 10, since the sensors are linearly distributed along the optical fiber 10, the optical fiber 10 functions as a line sensor.

The measurement unit 21 can specify a position where the optical signal is generated, that is, the generation position of the vibration on the road R detected based on the optical signal (a distance of the optical fiber 10 from the lane identification device 20) based on a time difference between a time where the pulsed light is transmitted to the optical fiber 10 and a time where the optical signal is received from the optical fiber 10.

In this manner, the measurement unit 21 can measure the amplitude and the occurrence position (the distance of the optical fiber 10 from the lane identification device 20) of the vibration generated on the road R as the vibration characteristic of the vibration.

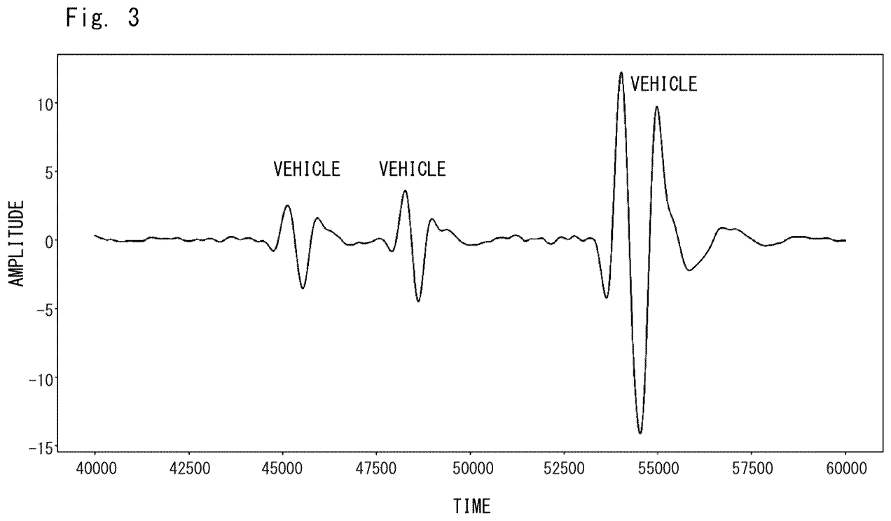

The learning unit 22 generates measurement data indicating a time-series vibration characteristic of vibration generated at an observation point that is any point on the road R in advance in the learning phase based on the measurement result of the measurement unit 21. FIG. 3 illustrates an example of measurement data of vibration generated at an observation point on the road R. In FIG. 3, the horizontal axis represents time, and the vertical axis represents amplitude of vibration.

While the vehicle travels on the road R, vibration is generated as the vehicle travels. The waveform of the vibration generated with the traveling of the vehicle has a waveform pattern in which the intensity of the vibration, the vibration position, the transition of the fluctuation of the frequency, and the like are unique.

Therefore, if the waveform of the measurement data of the vibration generated at the observation point on the road R includes a waveform having a waveform pattern unique to the traveling of the vehicle, the learning unit 22 detects that the vehicle associated with the waveform has passed through the observation point and cuts out the waveform. For example, in the example of FIG. 3, there are three waveforms associated with three vehicles. Therefore, the learning unit 22 detects three vehicles and cuts out three waveforms associated with the three vehicles.

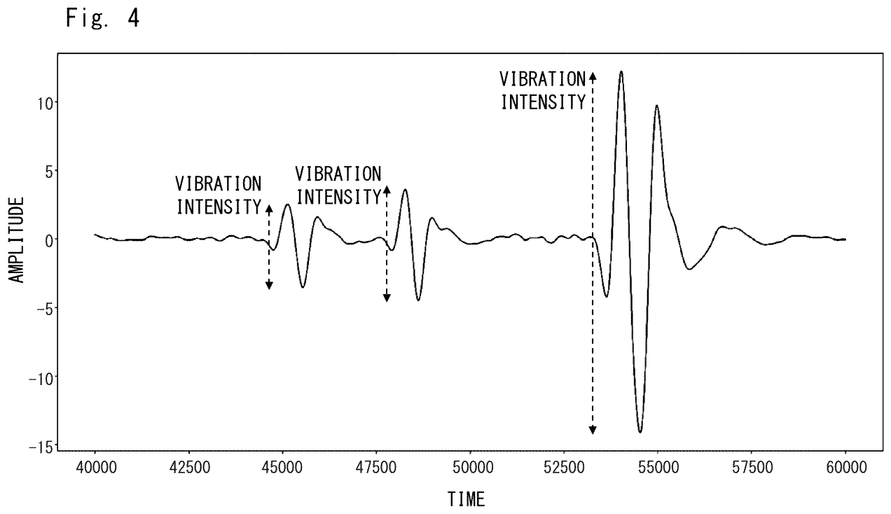

Next, the learning unit 22 derives the vibration intensity of the waveform as the feature amount based on the waveform associated with the vehicle that has passed through the observation point on the road R. FIG. 4 illustrates an example of the vibration intensity derived based on the waveform associated with the vehicle. As illustrated in FIG. 4, the vibration intensity is associated with a difference between the maximum peak value and the minimum peak value of the waveform.

Then, the learning unit 22 generates, for each vehicle classification of the vehicle, a feature amount model obtained by modeling a relationship between vibration intensity during the vehicle passes through the observation point on the road R and a lane on which the vehicle that has passed through the observation point is traveling. Specifically, the feature amount model is a model representing a boundary of the vibration intensity of each lane for each vehicle classification of the vehicle. The vehicle classification represents the size (weight) of a small vehicle, a normal vehicle, a large vehicle, or the like.

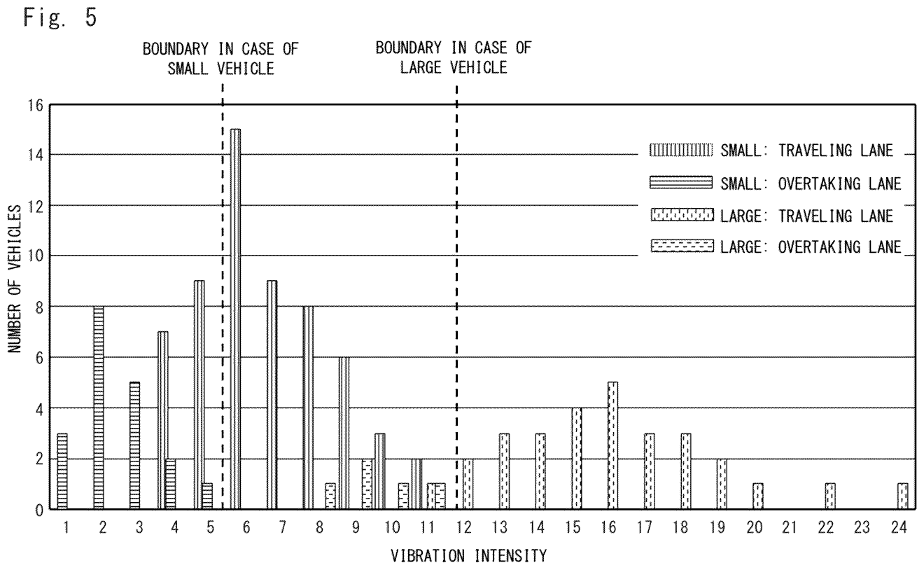

FIG. 5 illustrates an example of statistical data indicating the relationship between the vibration intensity during the vehicle passes through the observation point on the road R and the lane on which the vehicle that has passed through the observation point is traveling, for each vehicle classification of the vehicle. FIG. 5 illustrates an example in which the vehicle classification is two classes of small vehicles and large vehicles. In FIG. 5, the horizontal axis represents the vibration intensity, and the vertical axis represents the number of vehicles.

As illustrated in FIG. 5, the vibration intensity depends on a lane on which the vehicle is traveling and a vehicle classification of the vehicle. A lane closer to the optical fiber 10 is characterized by a larger vibration intensity. Therefore, the learning unit 22 can identify the lane from the vibration intensity and the vehicle classification by performing modeling using these features.

In the learning phase, the lane on which the vehicle that has passed through the observation point on the road R is traveling and the vehicle classification of the vehicle are known.

For example, if learning is performed at a location that can be monitored by a camera (not illustrated), the learning unit 22 can specify a lane on which the vehicle is traveling and a vehicle classification of the vehicle based on the camera data.

Alternatively, if learning is performed under a condition that the lane on which the vehicle is traveling can be grasped in advance, the learning unit 22 can specify the lane. For example, in a driving test of driving in a predetermined lane, the lane can be grasped in advance, and the above conditions are met.

Alternatively, the learning unit 22 may estimate the vehicle classification of the vehicle based on the measurement result of the measurement unit 21.

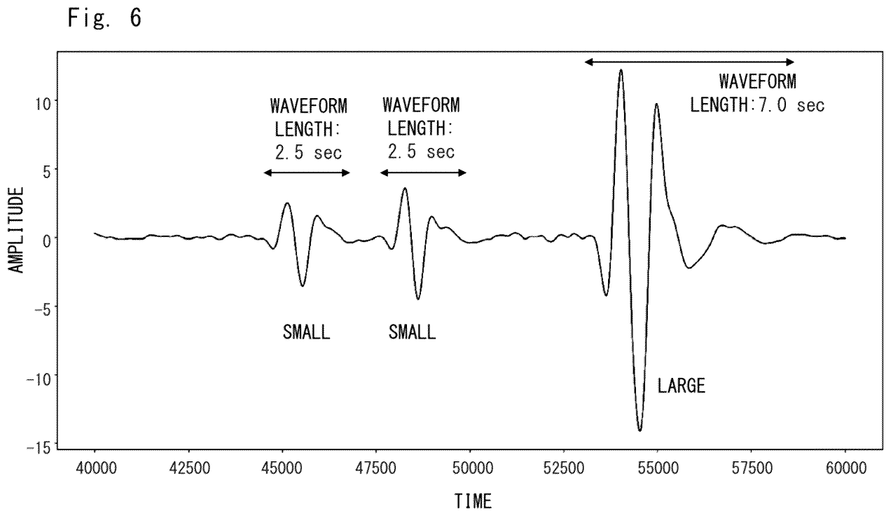

For example, the learning unit 22 cuts out a waveform associated with the vehicle that has passed through the observation point on the road R from the measurement data used for deriving the vibration intensity, and then derives the waveform length of the waveform as the feature amount based on the cut out waveform. FIG. 6 illustrates an example of a waveform length derived based on a waveform associated with the vehicle. As illustrated in FIG. 6, the waveform length is associated with the vibration duration time. Here, since the vehicle length becomes longer as the vehicle becomes larger, the vibration duration time becomes longer. Therefore, the learning unit 22 may estimate the vehicle classification based on the waveform length.

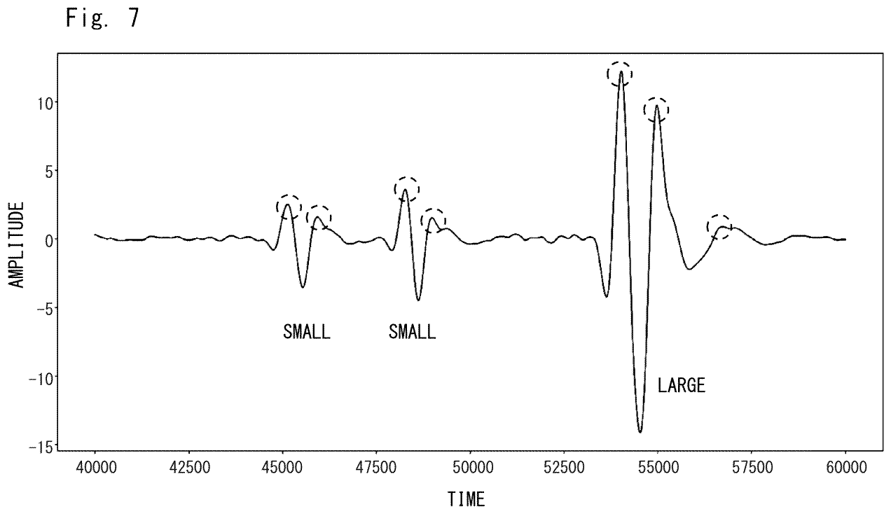

Alternatively, the learning unit 22 cuts out a waveform associated with the vehicle that has passed through the observation point on the road R from the measurement data, and then derives the number of peaks of the waveform as the feature amount based on the cut out waveform. FIG. 7 illustrates an example of the number of peaks derived based on the waveform associated with the vehicle. In the example of FIG. 7, portions surrounded by broken line circles are associated with the peaks. The peak is considered to occur as an axle of a vehicle passes through an observation point on the road R. Here, since the number of axles increases as the vehicle becomes larger, the number of peaks increases. Therefore, the learning unit 22 may estimate the vehicle classification based on the number of peaks.

In the operation phase, the identification unit 23 generates measurement data indicating a time-series vibration characteristic of vibration generated at an observation point on the road R based on the measurement result of the measurement unit 21. An example of the measurement data is similar to that in FIG. 3.

Next, the identification unit 23 detects a vehicle that has passed through an observation point based on a waveform of measurement data of vibration generated at the observation point on the road R, and cuts out a waveform associated with the vehicle that has passed through the observation point in a case where the vehicle that has passed through the observation point can be detected.

Next, the identification unit 23 derives the vibration intensity of the waveform as the feature amount based on the waveform associated with the vehicle that has passed through the observation point on the road R. Then, the identification unit 23 identifies the lane on which the vehicle that has passed through the observation point is traveling based on the derived vibration intensity, the vehicle classification of the vehicle that has passed through the observation point, and the feature amount model generated by the learning unit 22.

Then, the identification unit 23 outputs the identified lane as an identification result. The output destination of the identification result may be a management system that manages the road R, a terminal in a management room that manages the road R, or the like.

In the operation phase, the identification unit 23 may estimate the vehicle classification of the vehicle based on the measurement result of the measurement unit 21. A method of estimating the vehicle classification in the identification unit 23 may be similar to that of the learning unit 22 described above.

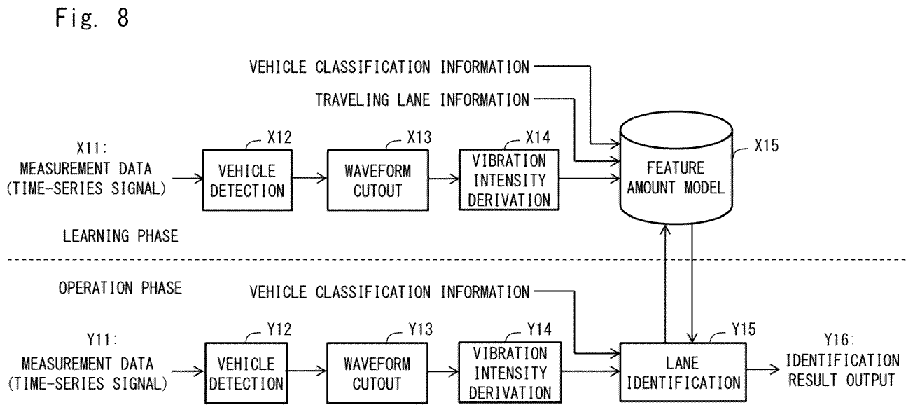

Next, a schematic operation example of the lane identification system according to the present first example embodiment will be described with reference to FIG. 8.

First, the operation of a learning phase will be described.

First, the learning unit 22 generates measurement data indicating a time-series vibration characteristic of vibration generated at an observation point on the road R based on the measurement result of the measurement unit 21 (step X11).

Next, the learning unit 22 detects the vehicle that has passed through the observation point based on the waveform of the measurement data of the vibration generated at the observation point on the road R (step X12). In a case where the vehicle that has passed through the observation point can be detected, the measurement unit 21 cuts out a waveform associated with the vehicle that has passed through the observation point (step X13).

Next, the learning unit 22 derives the vibration intensity of the waveform as the feature amount based on the waveform associated with the vehicle that has passed through the observation point on the road R (step X14).

Then, the learning unit 22 generates a feature amount model obtained by modeling the relationship between the vibration intensity during the vehicle passes through the observation point on the road R and the lane on which the vehicle that has passed through the observation point is traveling for each vehicle classification of the vehicle (step X15).

Next, the operation of an operation phase will be described.

First, the identification unit 23 generates measurement data indicating a time-series vibration characteristic of vibration generated at an observation point on the road R based on the measurement result of the measurement unit 21 (step Y11).

Next, the measurement unit 21 detects the vehicle that has passed through the observation point based on the waveform of the measurement data of the vibration generated at the observation point on the road R (step Y12). In a case where the vehicle that has passed through the observation point can be detected, the measurement unit 21 cuts out a waveform associated with the vehicle that has passed through the observation point (step Y13).

Next, the identification unit 23 derives the vibration intensity of the waveform as the feature amount based on the waveform associated with the vehicle that has passed through the observation point on the road R (step Y14).

Next, the identification unit 23 identifies the lane on which the vehicle that has passed through the observation point on the road R is traveling based on the derived waveform length, the vehicle classification of the vehicle that has passed through the observation point, and the feature amount model generated by the learning unit 22 (step Y15).

Thereafter, the identification unit 23 outputs the identified lane as an identification result for the vehicle that has passed through the observation point on the road R (step Y16).

As described above, according to the present first example embodiment, the measurement unit 21 measures the vibration characteristic of the vibration generated on the road R based on the optical signal received from the optical fiber 10. In the learning phase, the learning unit 22 derives the vibration intensity based on the vibration characteristic during the vehicle passes through the observation point on the road R among the vibration characteristics measured by the measurement unit 21, and generates a feature amount model obtained by modeling the relationship between the vibration intensity during the vehicle passes through the observation point on the road R and the lane on which the vehicle is traveling for each vehicle classification of the vehicle. In the operation phase, the identification unit 23 derives the vibration intensity based on the vibration characteristic during the vehicle passes through the observation point among the vibration characteristics measured by the measurement unit 21, and identifies the lane on which the vehicle is traveling based on the derived vibration intensity, the vehicle classification of the vehicle, and the feature amount model. In this manner, the lane on which the vehicle is traveling is identified using the vehicle classification of the vehicle in addition to the vibration intensity during the vehicle passes through the observation point. Therefore, it is possible to more accurately identify the lane on which the vehicle is traveling, as compared with the related art.

### Second Example Embodiment

In the first example embodiment described above, the lane on which the vehicle is traveling is identified using the vibration intensity during the vehicle passes through the observation point on the road R and the vehicle classification of the vehicle.

On the other hand, in the present second example embodiment, in addition to the vibration intensity during the vehicle passes through the observation point on the road R and the vehicle classification of the vehicle, the traveling speed of the vehicle is further used to identify the lane on which the vehicle is traveling.

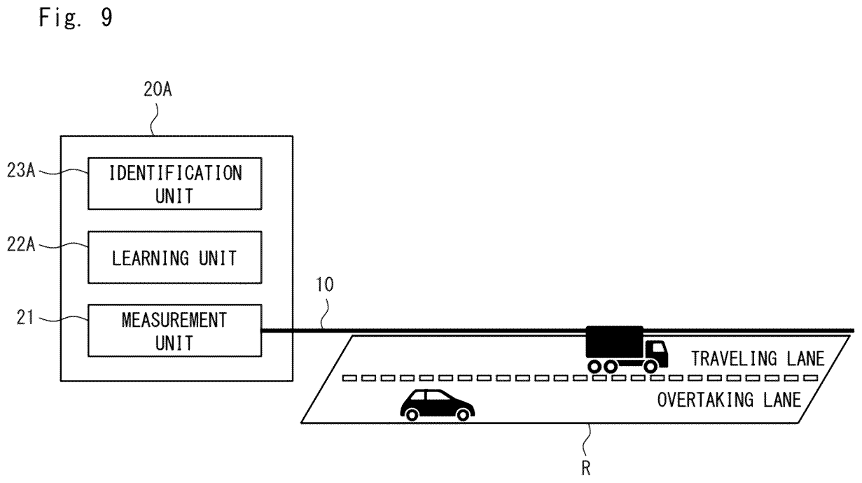

First, a schematic configuration example of a lane identification system according to the present second example embodiment will be described with reference to FIG. 9.

As illustrated in FIG. 9, the lane identification system according to the present second example embodiment has a configuration in which the lane identification device 20 is replaced with a lane identification device 20A as compared with the lane identification system according to the first example embodiment described above.

The lane identification device 20A has a configuration in which the learning unit 22 and the identification unit 23 are replaced with a learning unit 22A and an identification unit 23A as compared with the lane identification device 20 according to the above-described first example embodiment.

In advance, in the learning phase, the learning unit 22A generates measurement data (measurement data as illustrated in FIG. 3) indicating a time-series vibration characteristic of vibration generated at an observation point on the road R based on the measurement result of the measurement unit 21.

Next, the learning unit 22A detects a vehicle that has passed through an observation point based on a waveform of measurement data of vibration generated at the observation point on the road R, and cuts out a waveform associated with the vehicle that has passed through the observation point in a case where the vehicle that has passed through the observation point can be detected.

Next, the learning unit 22A derives the vibration intensity of the waveform as the feature amount based on the waveform associated with the vehicle that has passed through the observation point on the road R.

Then, the learning unit 22A generates, for each vehicle classification of the vehicle, a feature amount model obtained by modeling a relationship between the vibration intensity during the vehicle passes through the observation point on the road R, the traveling speed of the vehicle that has passed through the observation point, and the lane on which the vehicle that has passed through the observation point is traveling. Specifically, the feature amount model is a model representing a boundary between the vibration intensity and the traveling speed of each lane for each vehicle classification of the vehicle.

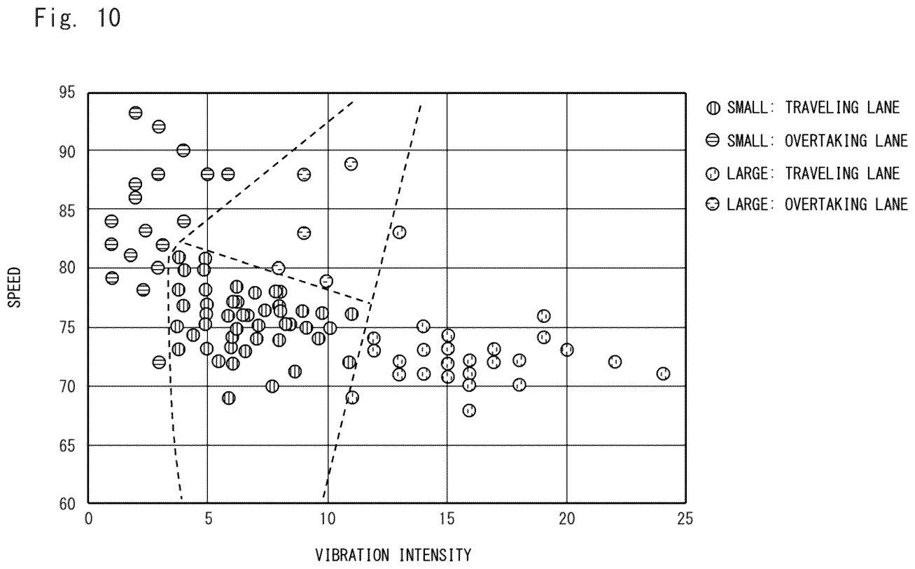

FIG. 10 illustrates an example of statistical data indicating the relationship between the vibration intensity during the vehicle passes through the observation point on the road R, the traveling speed of the vehicle that has passed through the observation point, and the lane on which the vehicle that has passed through the observation point is traveling, for each vehicle classification of the vehicle. FIG. 10 illustrates an example in which the vehicle classification is two classes of small vehicles and large vehicles. In FIG. 10, the horizontal axis represents the vibration intensity, and the vertical axis represents the traveling speed of the vehicle.

As illustrated in FIG. 10, the vibration intensity depends on a lane on which the vehicle is traveling and a vehicle classification of the vehicle. Further, there is a feature that the traveling speed depends on a lane on which the vehicle is traveling. A lane closer to the optical fiber 10 is characterized by a larger vibration intensity. Therefore, the learning unit 22A makes it possible to identify the lane from the vibration intensity, the vehicle classification, and the traveling speed by performing modeling using these features.

In the learning phase, the lane on which the vehicle that has passed through the observation point on the road R is traveling, the vehicle classification of the vehicle, and the traveling speed of the vehicle are known.

For example, if learning is performed at a location that can be monitored by a camera (not illustrated), the learning unit 22A can specify a lane on which the vehicle is traveling and a vehicle classification of the vehicle based on the camera data.

Alternatively, if learning is performed under a condition that the lane on which the vehicle is traveling can be grasped in advance, the learning unit 22A can specify the lane. For example, in a driving test of driving in a predetermined lane, the lane can be grasped in advance, and the above conditions are met.

Alternatively, the learning unit 22A may estimate the vehicle classification and the traveling speed of the vehicle based on the measurement result of the measurement unit 21.

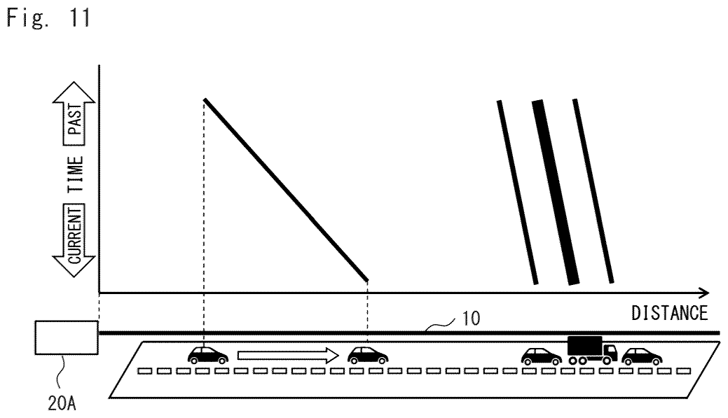

For example, the learning unit 22A generates measurement data as illustrated in FIG. 11 based on the measurement result of the measurement unit 21. In FIG. 11, the horizontal axis represents the distance of the optical fiber 10 from the lane identification device 20, and the vertical axis represents the time lapse of the time during the vibration occurs. The more positive along the vertical axis, the older the data.

In the measurement data illustrated in FIG. 11, that one vehicle is traveling on the road R is represented by one line obliquely. An absolute value of the inclination of the line represents the traveling speed of the vehicle, and the smaller the absolute value of the inclination of the line, the higher the traveling speed of the vehicle. The positive and negative inclinations of the line represent a traveling direction of the vehicle. The interval in the horizontal axis direction of the line represents the inter-vehicle distance between the vehicles, and the shorter the interval is, the shorter the inter-vehicle distance is.

Therefore, in the measurement data illustrated in FIG. 11, the learning unit 22A may specify the vehicle based on the time during the vehicle passes through the observation point, and estimate the traveling speed of the vehicle based on the absolute value of the inclination of the line associated with the vehicle.

The method of estimating the vehicle classification in the learning unit 22A may be similar to that in the first example embodiment described above.

In the operation phase, the identification unit 23A generates measurement data (measurement data as illustrated in FIG. 3) indicating a time-series vibration characteristic of vibration generated at an observation point on the road R based on the measurement result of the measurement unit 21.

Next, the identification unit 23A detects a vehicle that has passed through an observation point based on a waveform of measurement data of vibration generated at the observation point on the road R, and cuts out a waveform associated with the vehicle that has passed through the observation point during the vehicle that has passed through the observation point can be detected.

Next, the identification unit 23A derives the vibration intensity of the waveform as the feature amount based on the waveform associated with the vehicle that has passed through the observation point on the road R. Then, the identification unit 23A identifies the lane on which the vehicle that has passed through the observation point is traveling based on the derived vibration intensity, the vehicle classification and the traveling speed of the vehicle that has passed through the observation point, and the feature amount model generated by the learning unit 22A.

Then, the identification unit 23A outputs the identified lane as an identification result. The output destination of the identification result may be similar to that of the first example embodiment described above.

In the operation phase, the identification unit 23A may estimate the vehicle classification and the traveling speed of the vehicle based on the measurement result of the measurement unit 21. A method of estimating the vehicle classification and the traveling speed in the identification unit 23A may be similar to that of the learning unit 22A described above.

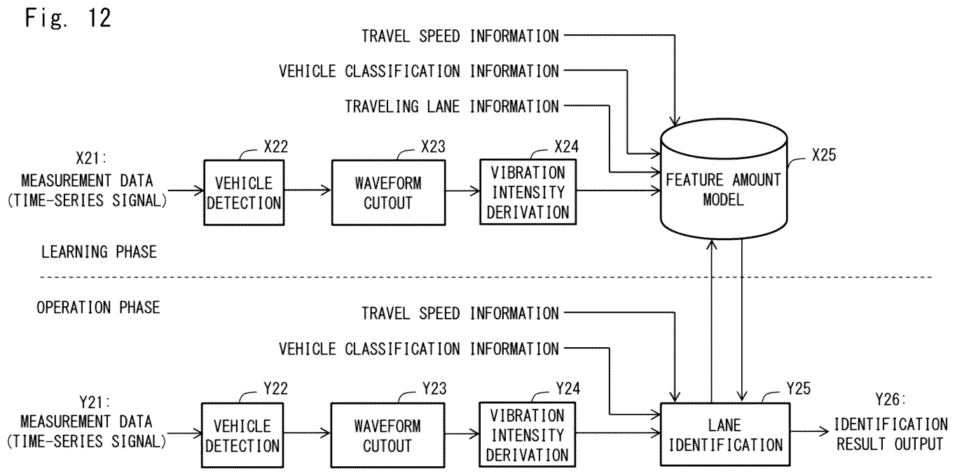

Next, a schematic operation example of the lane identification system according to the present second example embodiment will be described with reference to FIG. 12.

First, the operation of a learning phase will be described.

First, the learning unit 22A performs processing of steps X21 to X24 similar to steps X11 to X14 of FIG. 8 of the first example embodiment described above.

Then, the learning unit 22A generates, for each vehicle classification of the vehicle, a feature amount model obtained by modeling a relationship between the vibration intensity during the vehicle passes through the observation point on the road R, the traveling speed of the vehicle that has passed through the observation point, and the lane on which the vehicle that has passed through the observation point is traveling (step X25).

Next, the operation of an operation phase will be described.

First, the identification unit 23A performs processing of steps Y21 to Y24 similar to steps Y11 to Y14 of FIG. 8 of the first example embodiment described above.

Next, the identification unit 23A identifies the lane on which the vehicle that has passed through the observation point is traveling based on the derived vibration intensity, the vehicle classification and the traveling speed of the vehicle that has passed through the observation point on the road R, and the feature amount model generated by the learning unit 22A (step Y25).

Thereafter, the identification unit 23A outputs the identified lane as an identification result for the vehicle that has passed through the observation point on the road R (step Y26).

As described above, according to the present second example embodiment, the measurement unit 21 measures the vibration characteristics of the vibration generated on the road R, similarly to the first example embodiment described above. In the learning phase, the learning unit 22A derives the vibration intensity based on the vibration characteristic during the vehicle passes through the observation point on the road R among the vibration characteristics measured by the measurement unit 21, and generates a feature amount model obtained by modeling the relationship between the vibration intensity during the vehicle passes through the observation point on the road R, the traveling speed of the vehicle, and the lane on which the vehicle is traveling for each vehicle classification of the vehicle. In the operation phase, the identification unit 23A derives the vibration intensity based on the vibration characteristic during the vehicle passes through the observation point among the vibration characteristics measured by the measurement unit 21, and identifies the lane on which the vehicle is traveling based on the derived vibration intensity, the vehicle classification and the traveling speed of the vehicle, and the feature amount model. In this manner, the lane on which the vehicle is traveling is identified using the vehicle classification and the traveling speed of the vehicle in addition to the vibration intensity during the vehicle passes through the observation point. Therefore, it is possible to more accurately identify the lane on which the vehicle is traveling, as compared with the related art and the first example embodiment described above.

### Third Example Embodiment

The present third example embodiment is associated with an example embodiment that generalizes the first and second example embodiments described above.

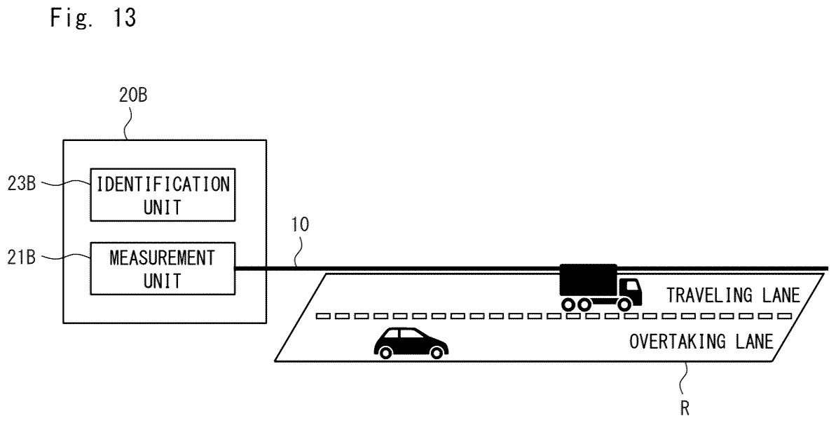

First, a schematic configuration example of a lane identification system according to the present third example embodiment will be described with reference to FIG. 13.

As illustrated in FIG. 13, the lane identification system according to the present third example embodiment includes an optical fiber 10 and a lane identification device 20B.

The lane identification device 20B includes a measurement unit 21B and an identification unit 23B.

The measurement unit 21B measures a vibration characteristic of vibration generated on the road R based on an optical signal received from the optical fiber 10 embedded in the road R.

The identification unit 23B derives the vibration intensity during the vehicle passes through the observation point on the road R based on the vibration characteristic during the vehicle passes through the observation point among the vibration characteristics measured by the measurement unit 21B. The identification unit 23B identifies the lane on which the vehicle that has passed through the observation point is traveling based on the derived vibration intensity and the vehicle classification of the vehicle that has passed through the observation point.

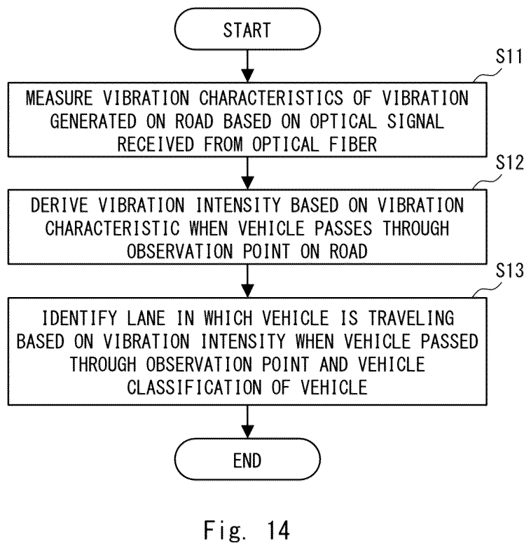

Next, an example of a schematic operation flow of the lane identification system according to the present third example embodiment will be described with reference to FIG. 14.

As illustrated in FIG. 14, first, the measurement unit 21B measures the vibration characteristic of the vibration generated on the road R based on the optical signal received from the optical fiber 10 embedded in the road R (step S11).

Next, the identification unit 23B derives the vibration intensity during the vehicle passes through the observation point on the road R based on the vibration characteristic during the vehicle passes through the observation point among the vibration characteristics measured by the measurement unit 21B (step S12).

Thereafter, the identification unit 23B identifies the lane on which the vehicle that has passed through the observation point is traveling based on the derived vibration intensity and the vehicle classification of the vehicle that has passed through the observation point (step S13).

As described above, according to the present third example embodiment, the measurement unit 21B measures the vibration characteristics of the vibration generated on the road R based on the optical signal received from the optical fiber 10 embedded in the road R. The identification unit 23B derives the vibration intensity during the vehicle passes through the observation point on the road R based on the vibration characteristic during the vehicle passes through the observation point among the vibration characteristics measured by the measurement unit 21B. The identification unit 23B identifies the lane on which the vehicle that has passed through the observation point is traveling based on the derived vibration intensity and the vehicle classification of the vehicle that has passed through the observation point. In this manner, the lane on which the vehicle is traveling is identified using the vehicle classification of the vehicle in addition to the vibration intensity during the vehicle passes through the observation point. Therefore, it is possible to more accurately identify the lane on which the vehicle is traveling, as compared with the related art.

The identification unit 23B may estimate the vehicle classification of the vehicle that has passed through the observation point based on the vibration characteristics during the vehicle has passed through the observation point on the road R, and identify the lane on which the vehicle that has passed through the observation point is traveling based on the derived vibration intensity and the estimated vehicle classification.

The lane identification device 20B may further include a learning unit that generates a feature amount model in which a relationship between vibration intensity during the vehicle passes through the observation point on the road R and a lane on which the vehicle that has passed through the observation point is traveling is modeled in advance for each vehicle classification of the vehicle. In this case, the identification unit 23B may identify the lane on which the vehicle that has passed through the observation point is traveling based on the derived vibration intensity, the vehicle classification of the vehicle that has passed through the observation point, and the feature amount model.

The identification unit 23B may identify the lane on which the vehicle that has passed the observation point is traveling based on the derived vibration intensity and the vehicle classification and traveling speed of the vehicle that has passed the observation point on the road R.

The identification unit 23B may estimate the vehicle classification and the traveling speed of the vehicle that has passed through the observation point based on the vibration characteristics of the vibration generated on the road R, and identify the lane on which the vehicle that has passed through the observation point is traveling based on the derived vibration intensity and the estimated vehicle classification and traveling speed.

The lane identification device 20B may further include a learning unit that generates a feature amount model in which a relationship between a vibration intensity during the vehicle passes through the observation point on the road R, a traveling speed of the vehicle that has passed through the observation point, and a lane on which the vehicle that has passed through the observation point is traveling is modeled in advance for each vehicle classification of the vehicle. In this case, the identification unit 23B may identify the lane on which the vehicle that has passed through the observation point is traveling based on the derived vibration intensity, the vehicle classification and the traveling speed of the vehicle that has passed through the observation point, and the feature amount model.

### Other Example Embodiments

In the first example embodiment described above, the learning unit 22 and the identification unit 23 are provided inside the lane identification device 20, but the present disclosure is not limited thereto. The learning unit 22 and the identification unit 23 may be provided in a separate device different from the lane identification device 20 or may be provided on a cloud.

The same applies to the learning unit 22A according to the second example embodiment described above and the identification units 23A and 23B according to the second and third example embodiments described above.

### Hardware Configuration of Lane Identification Device According to Each Example Embodiment

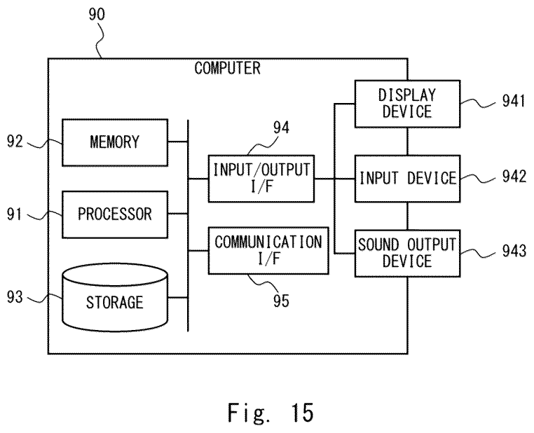

Next, a schematic hardware configuration example of a computer 90 that implements the lane identification devices 20, 20A, and 20B according to the above-described first to third example embodiments will be described with reference to FIG. 15.

As illustrated in FIG. 15, the computer 90 includes a processor 91, a memory 92, a storage 93, an input/output interface (input/output I/F) 94, a communication interface (communication I/F) 95, and the like. The processor 91, the memory 92, the storage 93, the input/output interface 94, and the communication interface 95 are connected by a data transmission path for mutually transmitting and receiving data.

The processor 91 is, for example, an arithmetic processing device such as a central processing unit (CPU) or a graphics processing unit (GPU). The memory 92 is, for example, a memory such as a random access memory (RAM) or a read only memory (ROM). The storage 93 is a storage device such as a hard disk drive (HDD), a solid state drive (SSD), or a memory card. The storage 93 may be a memory such as the RAM or the ROM.

The storage 93 stores a program for realizing functions of components included in the lane identification devices 20, 20A, and 20B. The processor 91 implements the functions of the components included in the lane identification devices 20, 20A, and 20B by executing these programs. Here, in execution of each of the programs described above, the processor 91 may load the programs into the memory 92, and may execute the programs, or may execute the programs without loading the programs into the memory 92. The memory 92 and the storage 93 also serve to store information and data held by the components included in the lane identification devices 20, 20A, and 20B.

The programs described above can be stored by using various types of non-transitory computer readable media, and can be supplied to a computer (including the computer 90). The non-transitory computer readable media include various types of tangible storage media. Examples of the non-transitory computer readable medium include a magnetic recording medium (for example, a flexible disk, a magnetic tape, or a hard disk drive), a magneto-optical recording medium (for example, a magneto-optical disk), a compact disc-ROM (CD-ROM), a CD-Recordable (CD-R), a CD-ReWritable (CD-R/W), and a semiconductor memory (for example, mask ROM, Programmable ROM (PROM), erasable PROM (EPROM), flash ROM, and RAM). The programs may be supplied to the computer by various types of transitory computer readable media. Examples of the transitory computer readable media include electrical signals, optical signals, and electromagnetic waves. The transitory computer readable media can supply the programs to the computer via a wired communication line such as an electric wire or an optical fiber, or a wireless communication line.

The input/output interface 94 is connected to a display device 941, an input device 942, a sound output device 943, and the like. The display apparatus 941 is an apparatus that displays a screen that corresponds to drawing data that has been processed by the processor 91 such as a liquid crystal display (LCD), a cathode ray tube (CRT) display, and monitor. The input apparatus 942 is an apparatus that receives an operation input of an operator, and is, for example, a keyboard, a mouse, a touch sensor, or the like. The display device 941 and the input device 942 may be integrated and implemented as a touch panel. The sound output device 943 is a device that acoustically outputs a sound associated with acoustic data processed by the processor 91, such as a speaker.

The communication interface 95 transmits and receives data to and from an external device. For example, the communication interface 95 performs communication with an external apparatus via the wired communication line or the wireless communication line.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims.

Some or all of the above-described example embodiments may be described in the following supplementary notes, but are not limited thereto.

### (Supplementary Note 1)

A lane identification system including:
an optical fiber embedded in a road;
a measurement unit that measures vibration characteristics of vibration generated on the road based on an optical signal received from the optical fiber; and
an identification unit that derives, based on a vibration characteristic during a vehicle passes through an observation point on the road among the vibration characteristics, a vibration intensity during the vehicle passes through the observation point, and identifies a lane on which the vehicle that has passed through the observation point is traveling based on the derived vibration intensity and a vehicle classification of the vehicle that has passed through the observation point.

### (Supplementary Note 2)

The lane identification system according to Supplementary Note 1, in which the identification unit estimates a vehicle classification of the vehicle that has passed through the observation point based on the vibration characteristic during the vehicle passes through the observation point; and identifies a lane on which the vehicle that has passed through the observation point is traveling, based on the derived vibration intensity and the estimated vehicle classification.

### (Supplementary Note 3)

The lane identification system according to Supplementary Note 1 or 2, further including a learning unit that generates a feature amount model in which a relationship between the vibration intensity during the vehicle passes through the observation point and the lane on which the vehicle that has passed through the observation point is traveling is modeled in advance for each vehicle classification of the vehicle,
in which the identification unit identifies the lane on which the vehicle that has passed through the observation point is traveling, based on the derived vibration intensity, the vehicle classification of the vehicle that has passed through the observation point, and the feature amount model.

### (Supplementary Note 4)

The lane identification system according to Supplementary Note 1, in which the identification unit identifies the lane on which the vehicle that has passed through the observation point is traveling, based on the derived vibration intensity and the vehicle classification and a traveling speed of the vehicle that has passed through the observation point.

### (Supplementary Note 5)

The lane identification system according to Supplementary Note 4, in which the identification unit estimates the vehicle classification and the traveling speed of the vehicle that has passed through the observation point based on the vibration characteristics, and identifies the lane on which the vehicle that has passed through the observation point is traveling based on the derived vibration intensity and the estimated vehicle classification and traveling speed.

### (Supplementary Note 6)

The lane identification system according to Supplementary Note 4 or 5, further including a learning unit that generates a feature amount model in which a relationship between the vibration intensity during the vehicle passes through the observation point, the traveling speed of the vehicle that has passed through the observation point, and the lane on which the vehicle that has passed through the observation point is traveling is modeled in advance for each vehicle classification of the vehicle,
wherein the identification unit identifies the lane on which the vehicle that has passed through the observation point is traveling, based on the derived vibration intensity, the vehicle classification and the traveling speed of the vehicle that has passed through the observation point, and the feature amount model.

### (Supplementary Note 7)

A lane identification device including:
a measurement unit that measures vibration characteristics of vibration generated on the road based on an optical signal received from an optical fiber embedded in a road; and
an identification unit that derives, based on a vibration characteristic during a vehicle passes through an observation point on the road among the vibration characteristics, a vibration intensity during the vehicle passes through the observation point, and identifies a lane on which the vehicle that has passed through the observation point is traveling based on the derived vibration intensity and a vehicle classification of the vehicle that has passed through the observation point.

### (Supplementary Note 8)

The lane identification device according to Supplementary Note 7, in which the identification unit estimates a vehicle classification of the vehicle that has passed through the observation point based on the vibration characteristic during the vehicle passes through the observation point; and identifies a lane on which the vehicle that has passed through the observation point is traveling, based on the derived vibration intensity and the estimated vehicle classification.

### (Supplementary Note 9)

The lane identification device according to Supplementary Note 7 or 8, further including a learning unit that generates a feature amount model in which a relationship between the vibration intensity during the vehicle passes through the observation point and the lane on which the vehicle that has passed through the observation point is traveling is modeled in advance for each vehicle classification of the vehicle,
in which the identification unit identifies the lane on which the vehicle that has passed through the observation point is traveling, based on the derived vibration intensity, the vehicle classification of the vehicle that has passed through the observation point, and the feature amount model.

### (Supplementary Note 10)

The lane identification device according to Supplementary Note 7, in which the identification unit identifies the lane on which the vehicle that has passed through the observation point is traveling, based on the derived vibration intensity and the vehicle classification and a traveling speed of the vehicle that has passed through the observation point.

### (Supplementary Note 11)

The lane identification device according to Supplementary Note 10, in which the identification unit estimates the vehicle classification and the traveling speed of the vehicle that has passed through the observation point based on the vibration characteristics, and identifies the lane on which the vehicle that has passed through the observation point is traveling based on the derived vibration intensity and the estimated vehicle classification and traveling speed.

### (Supplementary Note 12)

The lane identification device according to Supplementary Note 10 or 11, further including a learning unit that generates a feature amount model in which a relationship between the vibration intensity during the vehicle passes through the observation point, the traveling speed of the vehicle that has passed through the observation point, and the lane on which the vehicle that has passed through the observation point is traveling is modeled in advance for each vehicle
wherein the identification unit identifies the lane on which the vehicle that has passed through the observation point is traveling, based on the derived vibration intensity, the vehicle classification and the traveling speed of the vehicle that has passed through the observation point, and the feature amount model.

### (Supplementary Note 13)

A lane identification method executed by a lane identification device including:
a measurement step of measuring vibration characteristics of vibration generated on the road based on an optical signal received from an optical fiber embedded in a road; and
an identification step of deriving, based on a vibration characteristic during a vehicle passes through an observation point on the road among the vibration characteristics, a vibration intensity during the vehicle passes through the observation point, and identifying a lane on which the vehicle that has passed through the observation point is traveling based on the derived vibration intensity and a vehicle classification of the vehicle that has passed through the observation point.

### (Supplementary Note 14)

The lane identification method according to Supplementary Note 13, in which the identification step further includes estimating a vehicle classification of the vehicle that has passed through the observation point based on the vibration characteristic during the vehicle passes through the observation point; and identifying a lane on which the vehicle that has passed through the observation point is traveling, based on the derived vibration intensity and the estimated vehicle classification.

### (Supplementary Note 15)

The lane identification method according to Supplementary Note 13 or 14, further including a learning step of generating a feature amount model in which a relationship between the vibration intensity during the vehicle passes through the observation point and the lane on which the vehicle that has passed through the observation point is traveling is modeled in advance for each vehicle classification of the vehicle,
in which the identification step further includes identifying the lane on which the vehicle that has passed through the observation point is traveling, based on the derived vibration intensity, the vehicle classification of the vehicle that has passed through the observation point, and the feature amount model.

### (Supplementary Note 16)

The lane identification method according to Supplementary Note 13, in which the identification step further includes identifying the lane on which the vehicle that has passed through the observation point is traveling, based on the derived vibration intensity and the vehicle classification and a traveling speed of the vehicle that has passed through the observation point.

### (Supplementary Note 17)

The lane identification method according to Supplementary Note 16, in which the identification step further includes estimating the vehicle classification and the traveling speed of the vehicle that has passed through the observation point based on the vibration characteristics, and identifying the lane on which the vehicle that has passed through the observation point is traveling based on the derived vibration intensity and the estimated vehicle classification and traveling speed.

### (Supplementary Note 18)

The lane identification method according to Supplementary Note 16 or 17, further including a learning step of generating a feature amount model in which a relationship between the vibration intensity during the vehicle passes through the observation point, the traveling speed of the vehicle that has passed through the observation point, and the lane on which the vehicle that has passed through the observation point is traveling is modeled in advance for each vehicle classification of the vehicle,
in which the identification step includes identifying the lane on which the vehicle that has passed through the observation point is traveling, based on the derived vibration intensity, the vehicle classification and the traveling speed of the vehicle that has passed through the observation point, and the feature amount model.

### REFERENCE SIGNS LIST

10 optical fiber
21,21B measurement unit
22, 22A learning unit
23, 23A, 23B identification unit
30 camera
90 computer
91 processor
92 memory
93 storage
94 input/output interface
941 display device
942 input device
943 sound output device
95 communication interface

What is claimed is:

1. A lane identification system comprising:
an optical fiber embedded in a road;
at least one memory storing instructions, and
at least one processor configured to execute the instructions to;
measure vibration characteristics of vibration generated on the road based on an optical signal received from the optical fiber; and
derive based on a vibration characteristic during a vehicle passes through an observation point on the road among the vibration characteristics, a vibration intensity during the vehicle passes through the observation point, ; and
identify lane on which the vehicle that has passed through the observation point is traveling based on the derived vibration intensity and a vehicle classification of the vehicle that has passed through the observation point.

2. The lane identification system according to claim 1, wherein the at least one processor is further configured to execute the instructions to;
estimate a vehicle classification of the vehicle that has passed through the observation point based on the vibration characteristic during the vehicle passes through the observation point; and
identify a lane on which the vehicle that has passed through the observation point is traveling, based on the derived vibration intensity and the estimated vehicle classification.

3. The lane identification system according to claim 1, wherein the at least one processor is further configured to execute the instructions to;
generate feature amount model in which a relationship between the vibration intensity during the vehicle passes through the observation point and the lane on which the vehicle that has passed through the observation point is traveling is modeled in advance for each vehicle classification of the vehicle; and
identify the lane on which the vehicle that has passed through the observation point is traveling, based on the derived vibration intensity, the vehicle classification of the vehicle that has passed through the observation point, and the feature amount model.

4. The lane identification system according to claim 1, wherein the at least one processor is further configured to execute the instructions to identify the lane on which the vehicle that has passed through the observation point is traveling, based on the derived vibration intensity and the vehicle classification and a traveling speed of the vehicle that has passed through the observation point.

5. The lane identification system according to claim 4, wherein the at least one processor is further configured to execute the instructions to;
estimate the vehicle classification and the traveling speed of the vehicle that has passed through the observation point based on the vibration characteristics; and
identify the lane on which the vehicle that has passed through the observation point is traveling based on the derived vibration intensity and the estimated vehicle classification and traveling speed.

6. The lane identification system according to claim 4, wherein the at least one processor is further configured to execute the instructions to;
generate a feature amount model in which a relationship between the vibration intensity during the vehicle passes through the observation point, the traveling speed of the vehicle that has passed through the observation point, and the lane on which the vehicle that has passed through the observation point is traveling is modeled in advance for each vehicle classification of the vehicle; and
identify the lane on which the vehicle that has passed through the observation point is traveling, based on the derived vibration intensity, the vehicle classification and the traveling speed of the vehicle that has passed through the observation point, and the feature amount model.

7. A lane identification device comprising:
at least one memory storing instructions, and
at least one processor configured to execute the instructions to;
measure vibration characteristics of vibration generated on the road based on an optical signal received from an optical fiber embedded in a road; and
derive, based on a vibration characteristic during a vehicle passes through an observation point on the road among the vibration characteristics, a vibration intensity during the vehicle passes through the observation point; and
identify a lane on which the vehicle that has passed through the observation point is traveling based on the derived vibration intensity and a vehicle classification of the vehicle that has passed through the observation point.

8. The lane identification device according to claim 7, wherein the at least one processor is further configured to execute the instructions to;
estimate the vehicle classification of the vehicle that has passed through the observation point based on the vibration characteristic during the vehicle passes through the observation point; and
identify a lane on which the vehicle that has passed through the observation point is traveling, based on the derived vibration intensity and the estimated vehicle classification.

9. The lane identification device according to claim 7, wherein the at least one processor is further configured to execute the instructions to;
generate a feature amount model in which a relationship between the vibration intensity during the vehicle passes through the observation point and the lane on which the vehicle that has passed through the observation point is traveling is modeled in advance for each vehicle classification of the vehicle; and
identify wherein the lane on which the vehicle that has passed through the observation point is traveling, based on the derived vibration intensity, the vehicle classification of the vehicle that has passed through the observation point, and the feature amount model.

10. The lane identification device according to claim 7, wherein the at least one processor is further configured to execute the instructions to identify the lane on which the vehicle that has passed through the observation point is traveling, based on the derived vibration intensity and the vehicle classification and a traveling speed of the vehicle that has passed through the observation point.

11. The lane identification device according to claim 10, wherein the at least one processor is further configured to execute the instructions to;
estimate the vehicle classification and the traveling speed of the vehicle that has passed through the observation point based on the vibration characteristics; and
identify the lane on which the vehicle that has passed through the observation point is traveling based on the derived vibration intensity and the estimated vehicle classification and traveling speed.

12. The lane identification device according to claim 10, wherein the at least one processor is further configured to execute the instructions to;
generate a feature amount model in which a relationship between the vibration intensity during the vehicle passes through the observation point, the traveling speed of the vehicle that has passed through the observation point, and the lane on which the vehicle that has passed through the observation point is traveling is modeled in advance for each vehicle classification of the vehicle; and
identify the lane on which the vehicle that has passed through the observation point is traveling, based on the derived vibration intensity, the vehicle classification and the traveling speed of the vehicle that has passed through the observation point, and the feature amount model.

13. A lane identification method executed by a lane identification device comprising:
a measurement step of measuring vibration characteristics of vibration generated on the road based on an optical signal received from an optical fiber embedded in a road; and
an identification step of deriving, based on a vibration characteristic during a vehicle passes through an observation point on the road among the vibration characteristics, a vibration intensity during the vehicle passes through the observation point, and identifying a lane on which the vehicle that has passed through the observation point is traveling based on the derived vibration intensity and a vehicle classification of the vehicle that has passed through the observation point.

14. The lane identification method according to claim 13, wherein the identification step further comprises estimating a vehicle classification of the vehicle that has passed through the observation point based on the vibration characteristic during the vehicle passes through the observation point; and identifying a lane on which the vehicle that has passed through the observation point is traveling, based on the derived vibration intensity and the estimated vehicle classification.

15. The lane identification method according to claim 13, further comprising a learning step of generating a feature amount model in which a relationship between the vibration intensity during the vehicle passes through the observation point and the lane on which the vehicle that has passed through the observation point is traveling is modeled in advance for each vehicle classification of the vehicle,
wherein the identification step further comprises identifying the lane on which the vehicle that has passed through the observation point is traveling, based on the derived vibration intensity, the vehicle classification of the vehicle that has passed through the observation point, and the feature amount model.

16. The lane identification method according to claim 13, wherein the identification step further comprises identifying the lane on which the vehicle that has passed through the observation point is traveling, based on the derived vibration intensity and the vehicle classification and a traveling speed of the vehicle that has passed through the observation point.

17. The lane identification method according to claim 16, wherein the identification step further comprises estimating the vehicle classification and the traveling speed of the vehicle that has passed through the observation point based on the vibration characteristics, and identifying the lane on which the vehicle that has passed through the observation point is traveling based on the derived vibration intensity and the estimated vehicle classification and traveling speed.

18. The lane identification method according to claim 16, further comprising a learning step of generating a feature amount model in which a relationship between the vibration intensity during the vehicle passes through the observation point, the traveling speed of the vehicle that has passed through the observation point, and the lane on which the vehicle that has passed through the observation point is traveling is modeled in advance for each vehicle classification of the vehicle,
wherein the identification step comprises identifying the lane on which the vehicle that has passed through the observation point is traveling, based on the derived vibration intensity, the vehicle classification and the traveling speed of the vehicle that has passed through the observation point, and the feature amount model.
